(19) United States
(12) Patent Application Publication
(10) Pub. No.: US 2020/0079367 A1
(43) Pub. Date: Mar. 12, 2020

(54) OBSTACLE SENSING DEVICE, VEHICLE, AND OBSTACLE SENSING SYSTEM

(71) Applicant: SHOWA CORPORATION, Saitama (JP)

(72) Inventor: Hirokazu FUJIMOTO, Tochigi (JP)

(21) Appl. No.: 16/681,507

(22) Filed: Nov. 12, 2019

Related U.S. Application Data
(63) Continuation of application No. PCT/JP2017/024524, filed on Jul. 4, 2017.

(30) Foreign Application Priority Data
Jun. 22, 2017 (JP) 2017-122578

(51) Int. Cl. B60W 30/09; B60W 10/18; B60W 10/20; B60W 50/00; G06T 7/73; G06T 7/246; G06K 9/00; G08G 1/16

(52) U.S. Cl. CPC B60W 30/09; B60W 10/18; B60W 10/20; B60W 50/00; G06T 7/73; G06T 7/246; G06T 2207/30261; G08G 1/166; G08G 1/164; B60W 2550/10; B60W 2710/18; B60W 2710/20; B60W 2050/0077; G06K 9/00805

(57) ABSTRACT

An ECU (600) includes: an in-mirror image obtaining section (612) configured to obtain an in-mirror image reflected in a roadside mirror; and an obstacle estimating section (613) configured to estimate a position of an obstacle by referring to the in-mirror image.

### CROSS-REFERENCE TO RELATED APPLICATIONS

This application is a Continuation of PCT International Application No. PCT/JP2017/024524 filed in Japan on Jul. 4, 2017, which claims the benefit of Patent Application No. 2017-122578 filed in Japan on Jun. 22, 2017, the entire contents of which are hereby incorporated by reference.

### TECHNICAL FIELD

The present invention relates to an obstacle detecting device, a vehicle, and an obstacle detecting system.

### BACKGROUND ART

Techniques for detecting an obstacle existing around a vehicle are known. Such techniques are applied to, for example, autonomous driving techniques. Patent Literature 1 discloses a technique for automatically recognizing a nearby object reflected in a roadside mirror.

### CITATION LIST

### Patent Literature

[Patent Literature 1]

Japanese Patent Application Publication Tokukai No. 2010-122821 (Publication date: Jun. 3, 2010)

### SUMMARY OF INVENTION

### Technical Problem

In the techniques for detecting obstacles, it is preferable to be able to accurately estimate an obstacle even in a case where the obstacle is reflected in a roadside mirror.

### Solution to Problem

In order to attain the above object, an obstacle detecting device in accordance with an aspect of the present invention include: an obtaining section configured to obtain an in-mirror image reflected in a roadside mirror; an estimating section configured to estimate, by referring to the in-mirror image, a position of an obstacle.

### Advantageous Effects of Invention

With an aspect of the present invention, it is possible to accurately estimate an obstacle reflected in a roadside mirror.

### BRIEF DESCRIPTION OF DRAWINGS

FIG. 1 is a view schematically illustrating a configuration of a vehicle in accordance with Embodiment 1 of the present invention.

FIG. 2 is a block diagram schematically illustrating a configuration of an ECU in accordance with Embodiment 1 of the present invention.

FIG. 3 is a block diagram schematically illustrating a configuration of an obstacle detecting section in accordance with Embodiment 1 of the present invention.

FIG. 4 is a view illustrating an in-mirror image in accordance with Embodiment 1 of the present invention, the in-mirror image being reflected in a roadside mirror.

FIG. 5 is an explanatory view schematically illustrating a matching process in accordance with Embodiment 1 of the present invention.

FIG. 6 is a flowchart illustrating a flow of an obstacle detection process in accordance with Embodiment 1 of the present invention.

FIG. 7 is a view schematically illustrating a configuration of a vehicle system in accordance with Embodiment 2 of the present invention.

FIG. 8 is a sequence diagram illustrating a flow of an obstacle detection process in accordance with Embodiment 2 of the present invention.

FIG. 9 is a view schematically illustrating a configuration of a vehicle system in accordance with Embodiment 3 of the present invention.

FIG. 10 is a sequence diagram illustrating a flow of an obstacle detection process in accordance with Embodiment 3 of the present invention.

### DESCRIPTION OF EMBODIMENTS

### Embodiment 1

The following description will discuss Embodiment 1 of the present invention in detail.

(Configuration of Vehicle 900)

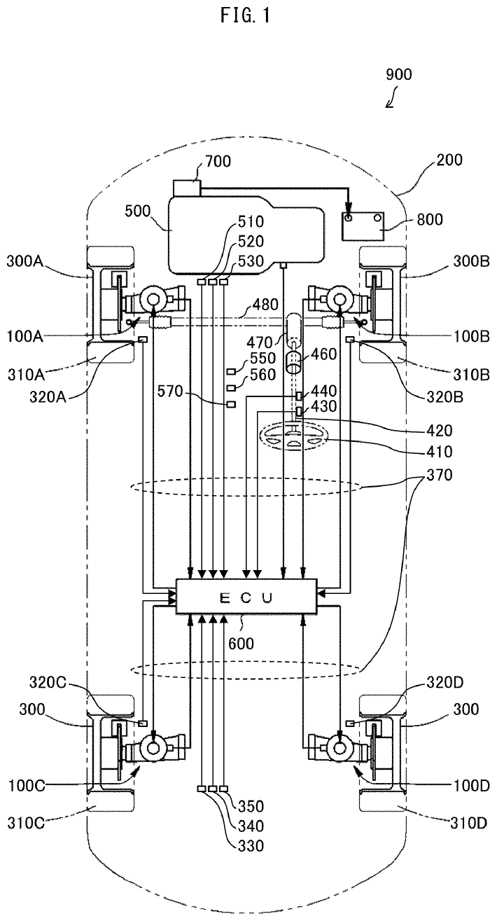

FIG. 1 is a view schematically illustrating a configuration of a vehicle 900 in accordance with Embodiment 1. As illustrated in FIG. 1, the vehicle 900 includes a suspension devices (suspensions) 100, a vehicle body 200, wheels 300, tires 310, a steering member 410, a steering shaft 420, a torque sensor 430, a steering angle sensor 440, a torque applying section 460, a rack-and-pinion mechanism 470, a rack shaft 480, an engine 500, an electronic control unit (ECU) (control section) 600, a power generating device 700, and a battery 800.

The wheels 300, on which the tires 310 are mounted, are suspended on the vehicle body 200 by the suspension devices 100. Because the vehicle 900 is a four-wheeled vehicle, there are provided four suspension devices 100, four wheels 300, and four tires 310.

A left front tire and a left front wheel will also be referred to as a tire 310A and a wheel 300A, respectively. A right front tire and a right front wheel will also be referred to as a tire 310B and a wheel 300B, respectively. A left rear tire and a left rear wheel will also be referred to as a tire 310C and a wheel 300C, respectively. A right rear tire and a right rear wheel will also be referred to as a tire 310D and a wheel 300D, respectively. Likewise, configurations associated with the left front wheel, the right front wheel, the left rear wheel, and the right rear wheel will also be expressed with the letters “A”, “B”, “C”, and “D”, respectively.

The suspension devices 100 each include a hydraulic buffer, an upper arm, and a lower arm. The hydraulic buffers includes a solenoid valve which is an electromagnetic valve configured to adjust a damping force generated by the hydraulic buffer. Note, however, that Embodiment 1 is not limited to this example. Alternatively, the hydraulic buffer can include an electromagnetic valve other than the solenoid valve as an electromagnetic valve for adjusting the damping force. For example, the hydraulic buffer can include an electromagnetic valve which utilizes an electromagnetic fluid (magnetic fluid).

To the engine 500, the power generating device 700 is provided. An electric power generated by the power generating device 700 is stored in the battery 800. The engine 500 is configured to be able to control an RPM according to vehicle speed controlled variables supplied from the ECU 600.

The steering member 410 to be operated by a driver is connected to one end part of the steering shaft 420 so that a torque can be transmitted from the steering member 410 to the steering shaft 420. The other end part of the steering shaft 420 is connected to the rack-and-pinion mechanism 470.

The rack-and-pinion mechanism 470 is a mechanism configured to convert a rotation around an axis of the steering shaft 420 into a rotation around an axis of the rack shaft 480. The conversion into the rotation around the rack shaft 480 steers the wheel 300A and the wheel 300B via tie rods and knuckle arms.

The torque sensor 430 detects a steering torque applied to the steering shaft 420. In other words, the torque sensor 430 detects a steering torque applied to the steering member 410. Then, the torque sensor 430 supplies, to the ECU 600, a torque sensor signal which indicates a result of the detection. More specifically, the torque sensor 430 detects twisting of a torsion bar provided in the steering shaft 420, and then outputs a result of the detection as a torque sensor signal. Note that the torque sensor 430 can be a well-known sensor such as a hall IC, an MR element, or a magnetostrictive torque sensor.

The steering angle sensor 440 detects a steering angle of the steering member 410, and then supplies a result of the detection to the ECU 600.

The torque applying section 460 applies, to the steering shaft 420, an assist torque or a reaction torque according to steering controlled variables supplied from the ECU 600. The torque applying section 460 includes (i) a motor configured to generate an assist torque or a reaction torque according to the steering controlled variables and (ii) a torque transmission mechanism via which the torque generated by the motor is transmitted to the steering shaft 420.

Concrete examples of “controlled variable” described herein encompass an electric current value, a duty ratio, an attenuation rate, and a damping ratio.

The steering member 410, the steering shaft 420, the torque sensor 430, the steering angle sensor 440, the torque applying section 460, the rack-and-pinion mechanism 470, the rack shaft 480, and the ECU 600 constitute a steering device in accordance with Embodiment 1.

Note that the term “connected . . . so that a torque can be transmitted” used in the above description means one member and the other member are connected so that a rotation of the one member generates a rotation of the other member. For example, the term “connected . . . so that a torque can be transmitted” at least encompasses (i) a case where one member and the other member are integrated, (ii) a case where one member is directly or indirectly fixed to the other member, and (iii) a case where one member and the other member are connected so as to operate in conjunction with each other via a joint member or the like.

The above example discussed the steering device in which the members from the steering member 410 to the rack shaft 480 are constantly and mechanically connected. However, Embodiment 1 is not limited to this example. The steering device in accordance with Embodiment 1 can be, for example, of a steer-by-wire system. Even to the steering device of a steer-by-wire system, the matters described below can be applied.

The vehicle 900 further includes (i) wheel speed sensors 320 which are provided to the respective wheels 300 and are configured to detect wheel speeds of the respective wheels 300, (ii) a horizontal G sensor 330 configured to detect a horizontal acceleration of the vehicle 900, (iii) a front-rear G sensor 340 configured to detect a front-rear acceleration of the vehicle 900, (iv) a yaw rate sensor 350 configured to detect a yaw rate of the vehicle 900, (v) an engine torque sensor 510 configured to detect a torque generated by the engine 500, (vi) an engine RPM sensor 520 configured to detect an RPM of the engine 500, and (vii) a brake pressure sensor 530 configured to detect a pressure applied to a brake fluid of a braking device. Information outputted from these sensors is supplied to the ECU 600 via a controller area network (CAN) 370.

The vehicle 900 further includes (i) a global positioning system (GPS) sensor 550 configured to identify a current position of the vehicle 900 and then output current location information which indicates the current position and (ii) a user input receiving section 560 configured to receive a user input concerning a destination location and then output destination location information which indicates the destination location. The current position information and the destination location information are supplied to the ECU 600 via the CAN 370. The vehicle 900 can further include a route information presenting section configured to visually or audibly present, to a user, a route indicated by route information generated by an obstacle detecting section 610 described later.

The vehicle 900 further includes a camera 570 configured to capture, at certain intervals, images of a surrounding environment of the vehicle 900, which surrounding environment includes an area in front of the vehicle 900. Embodiment 1 is not limited to the certain intervals. For example, the camera 570 captures 15 images per second. A captured image captured by the camera 570 is supplied to the ECU 600 via the CAN 370.

Although not illustrated, the vehicle 900 further includes the braking device capable of controlling (i) an antilock brake system (ABS) which is a system for preventing the wheels from being locked during breaking, (ii) a traction control system (TCS) for restricting idle running of the wheels during acceleration, and (iii) a vehicle stability assist (VSA) which is a vehicle behavior stabilization control system including an automatic braking function for, for example, yaw moment control and a brake assist function during swirling.

Note that with use of ABS, TCS, and VSA, a comparison is made between (i) a wheel speed determined according to an estimated vehicle body speed and (ii) a wheel speed detected by the wheel speed sensors 320. In a case where the respective values of these wheel speeds differ from each other by a certain amount or more, it is determined that the vehicle is slipping. Through such a process, ABS, TCS, and VSA carry out optimum brake control and optimum traction control according to a running state of the vehicle 900, so as to stabilize the behavior of the vehicle 900.

The braking device of the vehicle 900 is configured to carry out a braking operation according to vehicle speed controlled variables supplied from the ECU 600.

The ECU 600 centrally controls various electronic devices included in the vehicle 900. For example, the ECU 600 adjusts the steering controlled variables to be supplied to the torque applying section 460. This controls a strength of an assist torque or a reaction torque to be applied to the steering shaft 420.

The ECU 600 also controls opening/closing of the solenoid valve of the hydraulic buffer of the suspension devices 100 by supplying suspension controlled variables to the solenoid valve. For enabling such control, there is provided an electric power line which supplies a driving power from the ECU 600 to the solenoid valve.

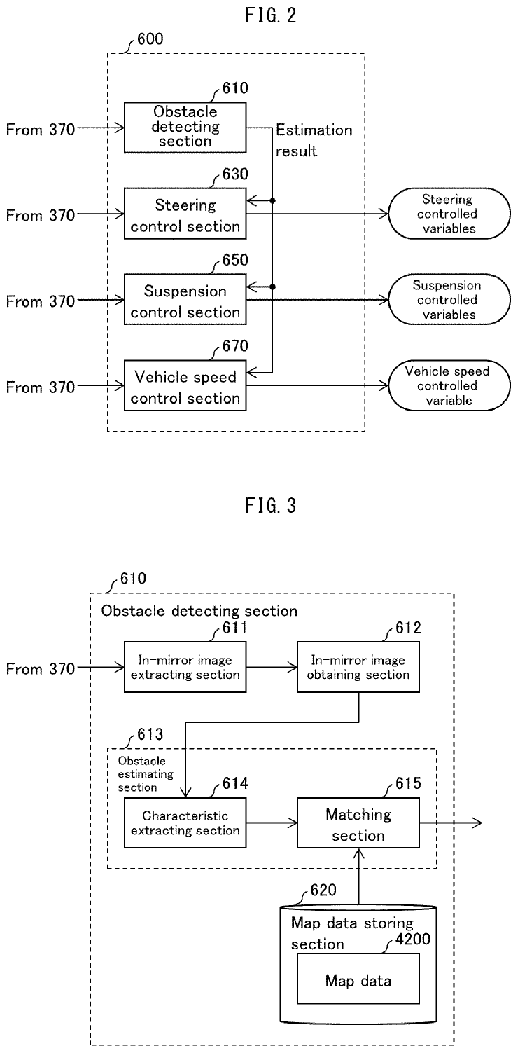

(ECU 600) The ECU 600 will be described in detail below with reference to another drawing. FIG. 2 is a view schematically illustrating a configuration of the ECU 600.

As illustrated in FIG. 2, the ECU 600 includes the obstacle detecting section (obstacle detecting device) 610, a steering control section 630, a suspension control section 650, and a vehicle speed control section 670.

The obstacle detecting section 610 is configured to make, by referring to an image captured by the camera 570, estimations concerning the present/absence of an obstacle and a position of the obstacle. The results of the estimations by the obstacle detecting section 610 concerning the obstacle are supplied to at least one of the steering control section 630, the suspension control section 650, and the vehicle speed control section 670.

By referring to at least one of (i) the results of the detections by the various sensors which results are included in the CAN 370 and (ii) the results of the estimations which results are supplied from the obstacle detecting section 610, the steering control section 630 decides an amount of steering controlled variable to be supplied to the torque applying section 460.

Note that the expression “by referring to” used herein may include such meanings as, for example, “by use of”, “in view of”, and “depending on”.

By referring to at least one of (i) the results of the detections by the various sensors which results are included in the CAN 370 and (ii) the results of the estimations which results are supplied from the obstacle detecting section 610, the suspension control section 650 decides an amount of suspension controlled variable to be supplied to the solenoid valve of the hydraulic buffer included in the suspension devices 100.

By referring to at least one of (i) the results of the detections by the various sensors which results are included in the CAN 370 and (ii) the results of the estimations which results are supplied from the obstacle detecting section 610, the vehicle speed control section 670 decides an amount of vehicle speed controlled variable to be supplied to the engine 500 and to the braking device.

Note that the obstacle detecting section 610, the steering control section 630, the suspension control section 650, and the vehicle speed control section 670 can be achieved by respective ECUs. In such a case, the control described herein is achieved by causing the obstacle detecting section 610, the steering control section 630, the suspension control section 650, and the vehicle speed control section 670 to communicate with each other via a communication section.

(Obstacle detecting section) The obstacle detecting section 610 will be described in more detail next with reference to FIG. 3. FIG. 3 is a block diagram illustrating a configuration of the obstacle detecting section 610. As illustrated in FIG. 3, the obstacle detecting section 610 includes an in-mirror image extracting section 611, an in-mirror image obtaining section (obtaining section) 612, an obstacle estimating section (estimating section) 613, and a map data storing section 620. In the map data storing section 620, map data 4200 is stored. The map data 4200 is referred to for estimating the present/absence and the position of an obstacle.

The in-mirror image extracting section 611 extracts an in-mirror image from a captured image which (i) has been captured by the camera 570 and (ii) is obtained via the CAN 370. A specific extraction process, in which the in-mirror image extracting section 611 extracts the in-mirror image, will be described later.

The in-mirror image obtaining section 612 obtains the in-mirror image extracted by the in-mirror image extracting section 611, and then supplies the in-mirror image to a characteristic extracting section 614.

By referring to the in-mirror image obtained by the in-mirror image obtaining section 612, the obstacle estimating section 613 estimates the present/absence and the position of an obstacle. The obstacle estimating section 613 includes the characteristic extracting section 614 and a matching section 615.

The characteristic extracting section 614 extracts a characteristic from the in-mirror image supplied from the in-mirror image obtaining section 612, and then supplies the characteristic to the matching section 615. A specific extraction process, in which the characteristic extracting section 614 extracts the characteristic from the in-mirror image, will be described later.

The matching section 615 makes a comparison between (i) the characteristic which is included in the in-mirror image and which has been extracted by the characteristic extracting section 614 and (ii) a characteristic included in the map data obtained from the map data storing section 620.

Then, the matching section 615 carries out a process (matching process) of associating the characteristic included in the in-mirror image and the characteristic included in the map data. In addition, the matching section 615 outputs results of an estimation concerning the obstacle, which results include the result of the matching process. A specific matching process by the matching section 615 will be described later.

The obstacle estimating section 613 corrects the position of the obstacle by making a comparison between (i) one or more characteristics extracted by the characteristic extracting section 614 and (ii) the map data 4200.

(In-Mirror Image Extraction Process)

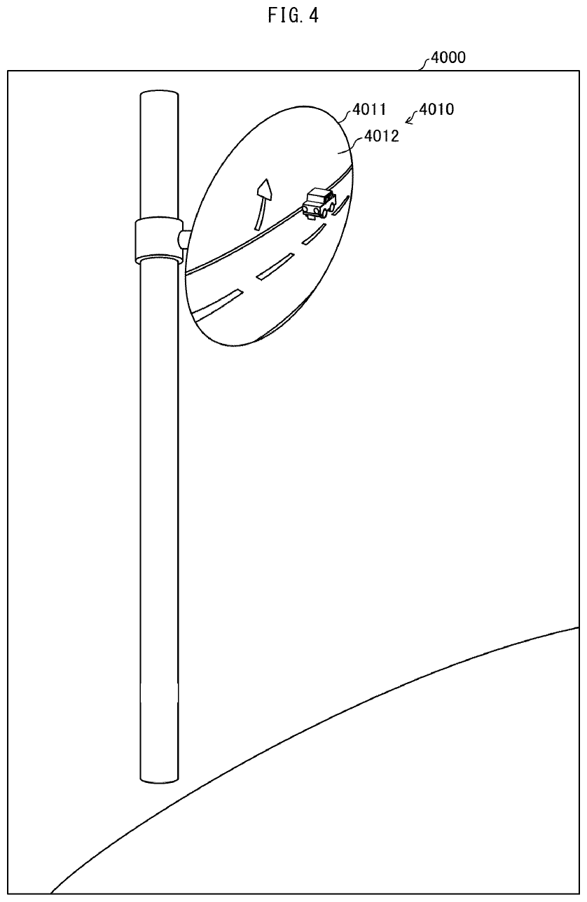

The extraction process, in which the in-mirror image extracting section 611 extracts the in-mirror image, will be described in detail next with reference to FIG. 4.

FIG. 4 is a view illustrating a captured image 4000 captured by the camera 570. In the captured image 4000, a roadside mirror 4010 is reflected.

The in-mirror image extracting section 611 extracts an in-mirror image 4012 in the roadside mirror 4010 through, for example, carrying out process 1 through 4 described below.

(Process 1)

An unnecessary background is deleted from the captured image 4000 by subjecting the captured image 4000 to a process of limiting hue with use of a hue filter.

(Process 2)

An outer edge(s) of a roadside mirror(s) is/are detected by subjecting the captured image 4000 to an edge detection process and a Hough transform process, so that a roadside mirror candidate(s) is/are detected.

(Process 3)

In a case where a plurality of roadside mirror candidates are detected, (i) scores concerning a chroma, a luma, a shape, and the like of each of the roadside mirror candidates are calculated and (ii) the roadside mirror 4010 is identified according to the scores.

(Process 4)

An image enclosed in an outer edge 4011 of the roadside mirror 4010 thus identified is extracted as the in-mirror image 4012.

(Characteristic Extraction Process)

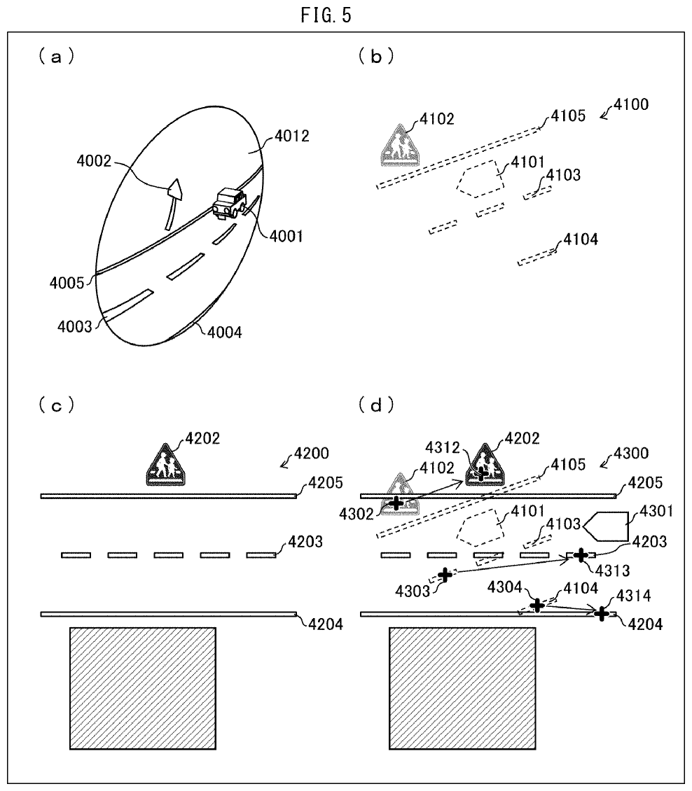

A characteristic extraction process carried out by the characteristic extracting section 614 will be described in detail next with reference to (a) through (d) of FIG. 5. In an example shown in (a) of FIG. 5, the following are reflected in the in-mirror image 4012: an obstacle 4001 (vehicle in the example of (a) of FIG. 5), a road sign 4002, a lane boundary (center line) 4003, roadway edge lines (side lines) 4004 and 4005.

First, the characteristic extracting section 614 generates a pre-processed in-mirror image 4100 by subjecting the in-mirror image 4012 to pre-processing. Embodiment 1 is not limited to this pre-processing. For example, the pre-processing can include (i) a process of deleting an unnecessary background through applying a hue filter and (ii) a process of making the edge clear by applying an edge enhancement filter. Note that the pre-processing is not essential. The in-mirror image 4012 can be used as the pre-processed in-mirror image 4100.

As illustrated in (b) of FIG. 5, the pre-processed in-mirror image 4100 includes an obstacle 4101, a road sign 4102, a lane boundary 4103, and roadway edge lines 4104 and 4105 which correspond to the obstacle 4001, the road sign 4002, the lane boundary 4003, and the roadway edge lines 4004 and 4005, respectively.

Then, by subjecting the pre-processed in-mirror image 4100 to a filter process, the characteristic extracting section 614 extracts one or more characteristics from the pre-processed in-mirror image 4100. Note that Embodiment 1 is not limited to any specific format of the filter process for extracting characteristics. For example, various filters such as a Sobel filter, a Gaussian filter, and a Laplacian filter can be used in combination. In addition, the characteristic extracting section 614 can be configured to calculate features by referring to the extracted characteristics.

Examples of a specific characteristic extraction process and a specific feature calculation process carried out by the characteristic extracting section 614 encompass methods below. Note, however, that Embodiment 1 is not limited to these methods.
Maximally Stable Extremal Regions (MSER)
Features from Accelerated Segment Test (FAST)
Harris point, Oriented-BRIEF (ORB)
Scale-Invariant Feature Transform (SIFT)
Speed-Up Robust Features (SURF)

Note that with ORB, SIFT, and SURF, not only are characteristics extracted, but features can also be calculated. In a case where any of MSER, FAST, and Harris point is used, for example, features can be calculated by use of any of ORB, SIFT, SURF, and the like after the characteristics are extracted.

For example, in a case where the characteristic extraction process is carried out by use of SIFT, the characteristic extracting section 614 first carries out an averaging process by subjecting the pre-processed in-mirror image 4100 to a Gaussian filter. Then, the characteristic extracting section 614 extracts the characteristics by subjecting the averaged image data to second derivative.

In a case where the feature calculation process is carried out by use of SIFT, for example, the characteristic extracting section 614 detects, from changes in luminance of areas around the extracted characteristics, a gradient orientation in which the change in luminance is greatest (i.e., a gradient orientation in which a luminance gradient is greatest). Then, the characteristic extracting section 614 associates, with the characteristics, information indicative of the gradient orientation thus detected. Next, the characteristic extracting section 614 calculates the features by referring to the gradient orientation of the characteristics.

Note that the number of characteristics to be extracted by the characteristic extracting section 614 is preferably more than one. In a case where the characteristic extracting section 614 extracts a plurality of characteristics, it is possible to improve an accuracy of the matching process described later. This makes it possible to accurately correct the position of the obstacle.

(d) of FIG. 5 shows an example in which the characteristic extracting section 614 respectively extracts a characteristic 4302, a characteristic 4303, and a characteristic 4304 from the road sign 4102, the lane boundary 4103, and the roadway edge line 4104 which are included in the pre-processed in-mirror image 4100.

In addition, the characteristic extracting section 614 detects the obstacle 4101 in the pre-processed in-mirror image 4100, and identifies the position of the obstacle 4101 thus detected. The obstacle 4101 can be detected by the characteristic extraction process described above. The position of the obstacle 4101 is identified by, for example, (i) identifying the coordinates of the obstacle 4101 in the pre-processed in-mirror image 4100 or (ii) identifying relative coordinates from each of the one or more characteristics extracted.

The characteristic extracting section 614 likewise extracts one or more characteristics from the map data 4200 illustrated in (c) of FIG. 5 by subjecting the map data 4200 to a characteristic extraction process. Then, the characteristic extracting section 614 calculates features by referring to the extracted characteristics.

(c) and (d) of FIG. 5 show an example in which the characteristic extracting section 614 respectively extracts a characteristic 4312, a characteristic 4313, and a characteristic 4314 from a road sign 4202, a lane boundary 4203, and a roadway edge line 4204 which are included in the map data 4200.

(Matching Process)

The matching section 615 carries out a matching process with use of (i) features calculated by referring to the one or more characteristics extracted from the pre-processed in-mirror image 4100 and (ii) features calculated by referring to the one or more characteristics extracted from the map data 4200.

The matching section 615 can be configured to carry out a matching process by maximizing a degree of match between the following features (i) and (ii) through subjecting the pre-processed in-mirror image 4100 including the one or more characteristics to at least one of a rotation process, an enlargement process, a shrinkage process, and a parallel translation process: (i) the features calculated by referring to the one or more characteristics included in the pre-processed in-mirror image 4100 and (ii) the features calculated by referring to the one or more characteristics included in the map data 4200. This process is carried out by, for example, minimizing an index indicative of a misalignment between (i) a position of each of the one or more characteristics included in the pre-processed in-mirror image 4100 and (ii) a position of each of the one or more characteristics included in the map data 4200. In a case where part of the characteristics included in the pre-processed in-mirror image is excessively misaligned, it is possible to minimize the index while ignore a characteristic(s) which is/are excessively misaligned.

By carrying out the matching process, the matching section 615 associates positions of objects in the pre-processed in-mirror image 4100 with positions of objects in the map data 4200. In the matching process, a matching parameter(s), which is used for associating corresponding characteristics with each other, is determined. Note that the matching parameter can include, for example, a parameter concerning at least one of the rotation process, the enlargement process, the shrinkage process, and the parallel translation process.

(d) of FIG. 5 schematically illustrates a case of respectively matching the characteristic 4302, the characteristic 4303, and the characteristic 4304 included in the pre-processed in-mirror image 4100 with the characteristic 4312, the characteristic 4313, and the characteristic 4314 which are included in the map data 4200. As illustrated in (d) of FIG. 5, (i) the characteristic 4302 is associated with the characteristic 4312, (ii) the characteristic 4303 is associated with the characteristic 4313, and (iii) the characteristic 4304 is associated with the characteristic 4314.

In addition, the matching section 615 estimates a position, in the map data 4200, of the obstacle 4101 of the pre-processed in-mirror image 4100. Such a position of the obstacle in the map data 4200 is estimated by converting, with use of the matching parameter, the position of the obstacle 4101 in the pre-processed in-mirror image 4100.

In a case where the characteristics extracted from the pre-processed in-mirror image 4100 are associated with the characteristics of the map data 4200 at a certain rate or more (e.g., 95% or more), the matching section 615 estimates that there is no obstacle in the pre-processed in-mirror image 4100.

The matching section 615 outputs, as results of estimation concerning the obstacle, information concerning the present/absence and the position of the obstacle in the map data 4200.

In the example shown in (a) through (d) of FIG. 5, the matching section 615 identifies, at the position indicated as the obstacle 4301 in the map data 4200, the position of the obstacle 4101 included in the pre-processed in-mirror image 4100. The matching section 615 also outputs, as results of estimation concerning the obstacle, information including the position of the obstacle 4301 in the map data 4200.

With the matching process, a problem of distortion of the in-mirror image 4012 is solved. In other words, with the matching process, the misalignment in the position of the obstacle, which misalignment results from the distortion of the in-mirror image 4012, is corrected. Examples of the distortion of the in-mirror image 4012 encompass (i) distortion resulting from the fact that a mirror surface of the roadside mirror 4010 is not flat, (ii) distortion resulting from a size of the mirror surface of the roadside mirror 4010, and (iii) distortion resulting from the fact that the in-mirror image 4012 is not an image of the roadside mirror 4010 viewed from the front (i.e., distortion resulting from an angle at which the roadside mirror 4010 is provided).

Therefore, the matching process by the matching section 615 can be expressed as a process of correcting the position of the obstacle by making a comparison between (i) the one or more characteristics extracted from the in-mirror image 4012 and (ii) the map data 4200.

(Flow of Obstacle Detection Process)

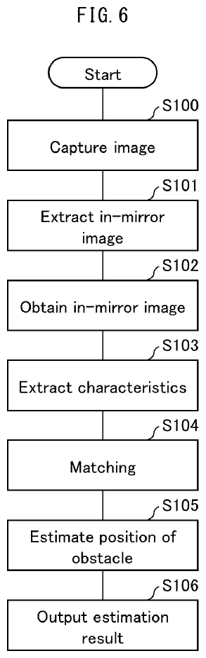

A flow, in which the obstacle detecting section 610 carries out a process of estimating the present/absence and the position of an obstacle, will be described next with reference to FIG. 6. FIG. 6 is a flowchart illustrating the flow in which the obstacle detecting section 610 carries out the process of estimating the present/absence and the position of an obstacle.

(Step S100)

First, in Step S100, the camera 570 provided in the vehicle 900 captures an image of a surrounding environment of the vehicle 900, which surrounding environment includes an area in front of the vehicle 900. Data indicative of the captured image is supplied to the obstacle detecting section 610 via the CAN 370.

(Step S101)

Then, in Step S101, the in-mirror image extracting section 611 extracts an in-mirror image from the captured image. The extraction process of extracting the in-mirror image was described earlier, and will therefore not be described here.

(Step S102)

Then, in Step S102, the in-mirror image obtaining section 612 obtains the in-mirror image extracted in Step S101. Then, the in-mirror image obtaining section 612 supplies the in-mirror image to the characteristic extracting section 614.

(Step S103)

Then, in Step S103, the characteristic extracting section 614 extracts one or more characteristics from the in-mirror image and from map data. The extraction process of extracting the characteristics was described earlier, and will therefore not be described here.

(Step S104)

Then, in Step S104, the matching section 615 matches the characteristics extracted from the in-mirror image with characteristics in the map data. The matching process of matching the characteristics was described earlier, and will therefore not be described here.

(Step S105)

Then, in Step S105, the matching section 615 estimates the present/absence and a position of an obstacle in map data 4200. The specific process of estimating the present/absence and the position of the obstacle was described earlier, and will therefore not be described here.

(Step S106)

Then, in Step S106, the matching section 615 supplies results of estimations in Step S106 concerning the present/absence and the position of the obstacle to the steering control section 630, the suspension control section 650, and the vehicle speed control section 670.

The obstacle detecting section 610 can be configured to carry out Steps S100 through S105 a plurality of times and then output the results of the estimations. In other words, the obstacle estimating section 613 can be configured to estimate the position of the obstacle by referring to a plurality of in-mirror images which are captured at respective points in time. In addition, the obstacle estimating section 613 can be configured to estimate the present/absence and the position of the obstacle by referring to a plurality of in-mirror images which are captured from respective positions.

Through a process in which Steps S100 through S105 are carried out a plurality of times, a position of an obstacle are estimated by referring to a plurality of in-mirror images which are captured from respective positions. This makes it possible to improve an accuracy of an estimation of the position of an obstacle.

In addition, through a process in which Steps S100 through S105 are carried out a plurality of times, it is possible to refer to a plurality of in-mirror images which are captured at respective points in time. Therefore, in a case where an obstacle is a moving object, it is also possible to estimate (i) a moving direction of the obstacle and (ii) a moving speed of the obstacle. The obstacle detecting section 610 is configured to (i) include, in the results of the estimations, the moving direction and the moving speed of the obstacle thus estimated and (ii) output the results of the estimations.

In the example described above, it is unnecessary that a characteristic and an obstacle are simultaneously reflected in a single in-mirror image. It is possible that while at least one of obstacles is moving, the vehicle 900 captures a plurality of images, and then carries out the process of estimating obstacles by referring to the plurality of images. This makes it possible to use, for the process of estimating obstacles, more characteristics extracted from a wider range which can be reflected in a roadside mirror. It is therefore possible to improve an estimation accuracy.

In the process of estimating the position, the moving direction, and the moving speed of the obstacle, the obstacle detecting section 610 can estimate the position, the moving direction, and the moving speed of the obstacle by further referring to steering information which is information concerning steering by the steering member 410. With such a configuration, it is possible to further improve an estimation accuracy.

<Vehicle Control According to Estimation Results>

The following description will discuss Control Examples 1 and 2 in which the ECU 600 controls the vehicle 900 by referring to the results of the estimations carried out by the obstacle detecting section 610. The ECU 600 can carry out control according to Control Example 1 and Control Example 2 in combination.

(Control Example 1)

In a case where the ECU 600 determines that a position of an obstacle indicated by results of estimations by the obstacle detecting section 610 is a dangerous position, the ECU 600 controls the vehicle 900 to stop. More specifically, by referring to the results of the estimations by the obstacle detecting section 610, the vehicle speed control section 670 determines whether or not the position of the obstacle indicated by the estimation results is a dangerous position. In a case where it is determined that the position is a dangerous position, the vehicle speed control section 670 controls, by changing vehicle speed controlled variables, the vehicle 900 to stop. The suspension control section 650 adjusts suspension controlled variables so as to allow the vehicle 900 to stop more stably.

Note that the vehicle speed control section 670 can change the vehicle speed controlled variables by further referring to current location information which indicates a current location of the vehicle 900. This allows an accuracy of vehicle control to be improved.

(Control Example 2)

In a case where the ECU 600 determines that a position of an obstacle indicated by results of estimations by the obstacle detecting section 610 is a dangerous position, the ECU 600 controls the vehicle 900 to avoid the obstacle. More specifically, by referring to the results of the estimations by the obstacle detecting section 610, the steering control section 630 determines whether or not the position of the obstacle indicated by the estimation results is a dangerous position. In a case where it is determined that the position is a dangerous position, the steering control section 630 controls, by changing the steering controlled variables, the vehicle 900 to avoid the obstacle. The suspension control section 650 adjusts suspension controlled variables so as to allow the vehicle 900 to avoid the obstacle more stably.

Note that the steering control section 630 can change the steering controlled variables by further referring to current location information which indicates a current location of the vehicle 900. This allows an accuracy of vehicle control to be improved.

### Embodiment 2

The following description will discuss Embodiment 2 of the present invention in detail with reference to other drawings. In the following description, members which were described in Embodiment 1 are given the same reference signs, and will not be described. The points which differ from Embodiment 1 will be described below.

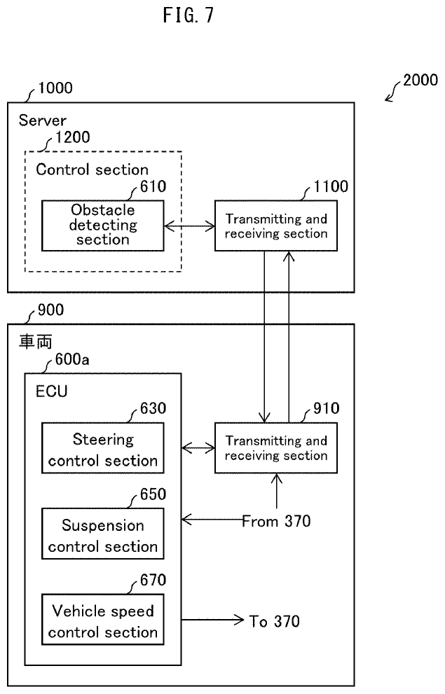

FIG. 7 is a view illustrating a main configuration of a vehicle system (obstacle detecting system) 2000 in accordance with Embodiment 2. The vehicle system 2000 includes a vehicle 900 and a server 1000. The vehicle 900 includes (i) an ECU 600a configured to control the vehicle 900 and (ii) a transmitting and receiving section 910 configured to cause the server 1000 and the vehicle 900 to transmit/receive data to/from each other.

The server 1000 includes (i) a control section 1200 including an obstacle detecting section 610 and (ii) a transmitting and receiving section 1100 configured to cause the server 1000 and the vehicle 900 to transmit/receive data to/from each other. In Embodiment 2, the server 1000 includes the obstacle detecting section 610 so as to carry out an in-mirror image extraction process, a characteristic extraction process, a matching process, and a process of estimating the present/absence and a position of an obstacle. Then, estimation results are transmitted from the server 1000 to the vehicle 900.

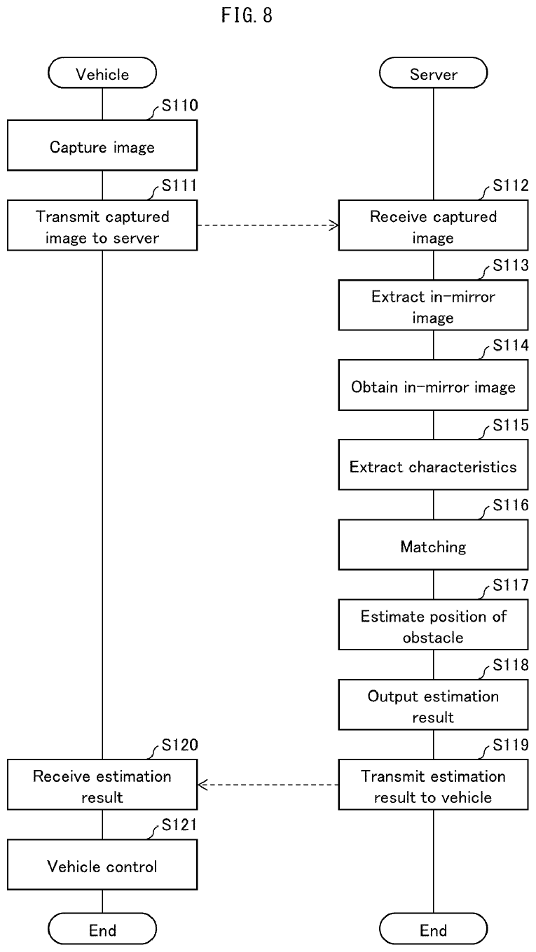

FIG. 8 is a sequence diagram of obstacle detection carried out by the vehicle system 2000 in accordance with Embodiment 2.

(Step S110)

In Step S110, a camera 570 provided in the vehicle 900 captures an image of a surrounding environment of the vehicle 900, which surrounding environment includes an area in front of the vehicle 900, as in Step S100 of Embodiment 1. Data indicative of the captured image is supplied to the transmitting and receiving section 910 via a CAN 370.

(Step S111)

Then, in Step S111, the transmitting and receiving section 910 transmits the captured image to the transmitting and receiving section 1100 of the server 1000.

(Step S112)

Then, in Step S112, the transmitting and receiving section 1100 receives the captured image transmitted from the transmitting and receiving section 910 in Step S111. Then, the transmitting and receiving section 1100 supplies, to the obstacle detecting section 610, the captured image thus obtained.

(Step S113)

Then, in Step S113, the obstacle detecting section 610 carries out an in-mirror image extraction process. The details of the in-mirror image extraction process are similar to those of Embodiment 1.

(Step S114)

Then, in Step S114, the obstacle detecting section 610 carries out an in-mirror image obtaining process. The details of the in-mirror image obtaining process are similar to those of Embodiment 1.

(Step S115)

Then, in Step S115, the obstacle detecting section 610 carries out a characteristic extraction process. The details of the characteristic extraction process are similar to those of Embodiment 1.

(Step S116)

Then, in Step S116, the obstacle detecting section 610 carries out a matching process. The details of the matching process are similar to those of Embodiment 1.

(Step S117)

Then, in Step S117, the obstacle detecting section 610 carries out a process of estimating the present/absence and the position of the obstacle. The details of the process of estimating the present/absence and the position of the obstacle are similar to those of Embodiment 1.

(Step S118)

Then, in Step S118, a matching section 615 of the obstacle detecting section 610 supplies, to the transmitting and receiving section 1100, results of estimations in Step S117 concerning the present/absence and the position of the obstacle.

(Step S119)

Then, in Step S119, the transmitting and receiving section 1100 transmits the estimation results to the transmitting and receiving section 910 of the vehicle 900.

(Step S120)

Then, in Step S120, the transmitting and receiving section 910 of the vehicle 900 receives the estimation results from the transmitting and receiving section 1100. The transmitting and receiving section 910 supplies the estimation results to the ECU 600a.

(Step S121)

Then, in Step S121, as described in Embodiment 1, the ECU 600a carries out vehicle control according to the estimation results by referring to the estimation results.

In Embodiment 2, the in-mirror image extraction process, the characteristic extraction process, the matching process, and the process of estimating the present/absence and the position of the obstacle are carried out by the server 1000. This allows the ECU 600a to be achieved with use of a relatively simple configuration. In addition, since it is unnecessary for the ECU 600a to retain map data, a memory load on the ECU 600a can be reduced.

### Embodiment 3

The following description will discuss Embodiment 3 of the present invention in detail with reference to other drawings. In the following description, members which were described in Embodiments 1 and 2 are given the same reference signs, and will not be described. The points which differ from Embodiments 1 and 2 will be described below.

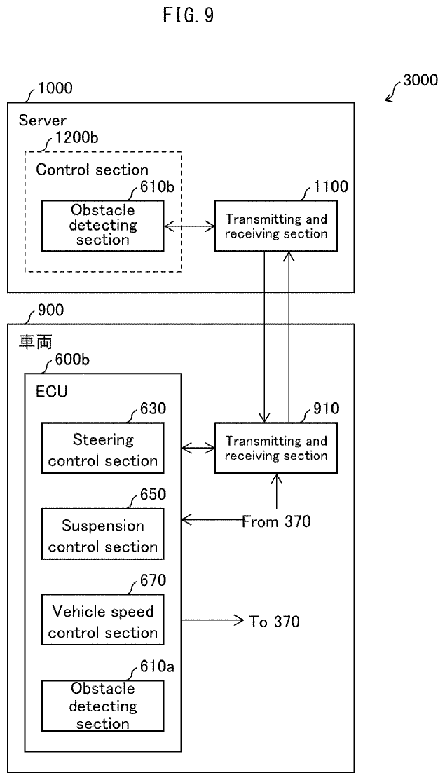

FIG. 9 is a view illustrating a main configuration of a vehicle system (obstacle detecting system) 3000 in accordance with Embodiment 3. The vehicle system 3000 includes a vehicle 900 and a server 1000. The vehicle 900 includes (i) an ECU 600b configured to control the vehicle 900 and (ii) a transmitting and receiving section 910. The ECU 600b includes an obstacle detecting section 610a, a steering control section 630, a suspension control section 650, and a vehicle speed control section 670.

The server 1000 includes (i) a control section 1200b including an obstacle detecting section 610b and (ii) a transmitting and receiving section 1100.

In Embodiment 3, the vehicle 900 and the server 1000 include the obstacle detecting sections 610a and 610b, respectively. Therefore, the processes carried out by the obstacle detecting section 610 in Embodiment 1 are distributed between the obstacle detecting sections 610a and 610b in Embodiment 3.

For example, the following description will discuss a configuration in which (i) the vehicle 900 carries out an in-mirror image extraction process and a characteristic extraction process described in Embodiment 1, (ii) the vehicle 900 transmits data on characteristics to the server 1000, (iii) with use of the data received, the server 1000 carries out a matching process and a process of estimating the present/absence and the position of the obstacle described in Embodiment 1, and (iv) the server 1000 transmits the estimation results to the vehicle 900.

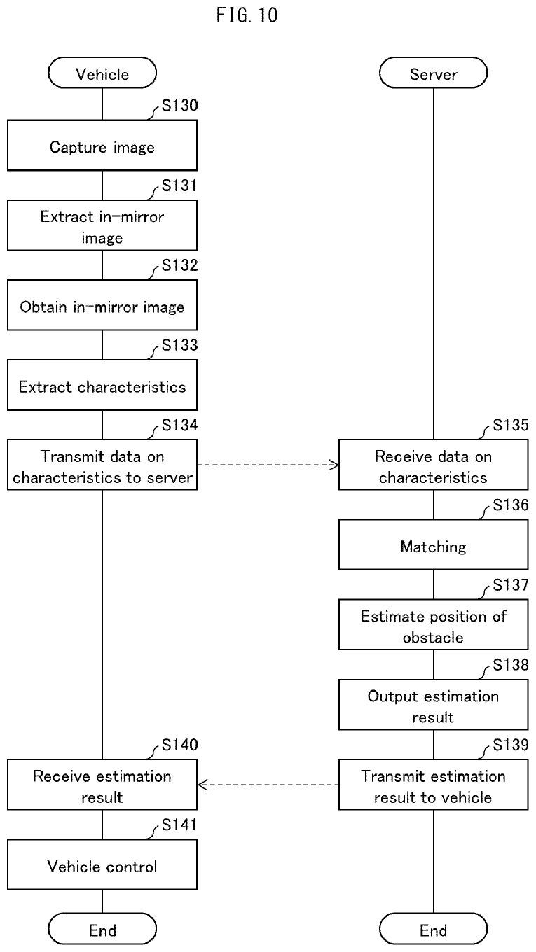

FIG. 10 is a sequence diagram of obstacle detection carried out by the vehicle system 3000 in accordance with Embodiment 3.

(Step S130)

First, in Step S130, a camera 570 provided in the vehicle 900 captures an image of a surrounding environment of the vehicle 900, which surrounding environment includes an area in front of the vehicle 900. Data indicative of the captured image is supplied to the obstacle detecting section 610a via a CAN 370.

(Step S131)

Then, in Step S131, the obstacle detecting section 610a carries out the in-mirror image extraction process. The details of the in-mirror image extraction process are similar to those of Embodiment 1.

(Step S132)

Then, in Step S132, the obstacle detecting section 610a carries out the in-mirror image obtaining process. The details of the in-mirror image obtaining process are similar to those of Embodiment 1.

(Step S133)

Then, in Step S133, the obstacle detecting section 610a extracts one or more characteristics from the in-mirror image. The extraction process of extracting the characteristics was described earlier, and will therefore not be described here. The obstacle detecting section 610a supplies, to the transmitting and receiving section 910, data indicative of the characteristics thus extracted.

(Step S134)

Then, in Step S134, the transmitting and receiving section 910 transmits, to the transmitting and receiving section 1100 of the server 1000, the data indicative of the characteristics extracted in Step S133.

(Step S135)

Then, in Step S135, the transmitting and receiving section 1100 receives the data which is supplied from the transmitting and receiving section 910 and which indicates the characteristics. The transmitting and receiving section 1100 supplies the data to the obstacle detecting section 610b.

(Step S136)

Then, in Step S136, the obstacle detecting section 610b carries out the matching process. Note that characteristics in map data, which is used in the matching process, can be those extracted by the obstacle detecting section 610a or those extracted by the obstacle detecting section 610b. The details of the matching process are similar to those of Embodiment 1.

(Step S137)

Then, in Step S137, the obstacle detecting section 610b carries out the process of estimating the present/absence and the position of the obstacle. The details of the process of estimating the present/absence and the position of the obstacle are similar to those of Embodiment 1.

(Step S138)

Then, in Step S138, the obstacle detecting section 610b supplies, to the transmitting and receiving section 1100, results of estimations in Step S137 concerning the present/absence and the position of the obstacle.

(Step S139)

Then, in Step S139, the transmitting and receiving section 1100 transmits the estimation results to the transmitting and receiving section 910 included in the vehicle 900.

(Step S140)

Then, in Step S140, the transmitting and receiving section 910 receives the estimation results from the transmitting and receiving section 1100. The transmitting and receiving section 910 supplies the estimation results to the ECU 600b.

(Step S141)

Then, in Step S141, as described in Embodiment 1, the ECU 600b carries out vehicle control according to the estimation results by referring to the estimation results.

In Embodiment 3, the matching process and the process of estimating the present/absence and the position of the obstacle are carried out by the server 1000. This allows the ECU 600b to be achieved with use of a relatively simple configuration. In addition, since it is unnecessary for the ECU 600b to retain map data, a memory load on the ECU 600b can be reduced.

It should be noted that the distributing process described in Embodiment 3 is illustrative only, and the invention described herein is not limited to such an example. For example, it is possible to provide any of or any combination of the in-mirror image obtaining section 612, the obstacle estimating section 613, and the characteristic extracting section 614 in the vehicle 900 so as to cause the vehicle 900 to carry out any of or any combination of the in-mirror image obtaining process, the obstacle detection process, and the characteristic extraction process.

### Embodiment 4

Embodiments 1 through 3 above discussed an example in which results of estimations concerning an obstacle are obtained by referring to an image captured by the vehicle 900 and are used by the vehicle 900. However, the invention described herein is not limited to such an example.

For example, Embodiments 1 through 3 can be modified so that results of estimations concerning an obstacle are obtained by referring to an image captured by the vehicle 900 and are supplied to another vehicle. Such a configuration can be made possible by, for example, use of a server which is configured to be able to communicate with a plurality of vehicles. More specifically, for example, the server 1000 described in Embodiment 2 can be configured to be able to communicate with one or more vehicles other than the vehicle 900 so that (i) the server 1000 records results of estimations, concerning an obstacle, carried out by the ECU 600 by referring to an image captured by the vehicle 900 (i.e., records information concerning the position of the obstacle) and then (ii) the server 1000 transmits the recorded estimations results to the one or more vehicles other than the vehicle 900. In addition, a vehicle, which received the estimation results, can carry out vehicle control according to the estimation results. Alternatively, the vehicle, which received the estimation results, can estimate the position of the obstacle by referring to the estimation results, and then carry out vehicle control according to the result of the estimation of the position.

By thus sharing estimation results among a plurality of vehicles, it is possible to effectively utilize the estimation results.

[Software Implementation Example]

Control blocks described as the ECUs 600, 600a, and 600b and the control sections 1200 and 1200b (particularly, the obstacle detecting sections 610, 610a, and 610b, the steering control section 630, the suspension control section 650, and the vehicle speed control section 670) can be realized by a logic circuit (hardware) provided in an integrated circuit (IC chip) or the like or can be alternatively realized by software as executed by a central processing unit (CPU).

In the latter case, the ECUs 600, 600a, and 600b and the control sections 1200 and 1200b each include a CPU that executes instructions of a program that is software realizing the foregoing functions; a read only memory (ROM) or a storage device (each referred to as “storage medium”) in which the program and various kinds of data are stored so as to be readable by a computer (or a CPU); and a random access memory (RAM) in which the program is loaded. An object of the present invention can be achieved by a computer (or a CPU) reading and executing the program stored in the storage medium. Examples of the storage medium encompass “a non-transitory tangible medium” such as a tape, a disk, a card, a semiconductor memory, and a programmable logic circuit. The program can be made available to the computer via any transmission medium (such as a communication network or a broadcast wave) which allows the program to be transmitted. Note that the present invention can also be achieved in the form of a computer data signal in which the program is embodied via electronic transmission and which is embedded in a carrier wave.

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

600 ECU (control section)
610 Obstacle detecting section
612 In-mirror image obtaining section (obtaining section)
613 Obstacle estimating section (estimating section)
630 Steering control section
650 Suspension control section
670 Vehicle speed control section
900 Vehicle

1. An obstacle detecting device comprising:
an obtaining section configured to obtain an in-mirror image reflected in a roadside mirror; and
an estimating section configured to estimate, by referring to the in-mirror image, a position of an obstacle,
the estimating section being configured to correct the position of the obstacle by making a comparison between (i) one or more characteristics extracted from the in-mirror image and (ii) map data.

2. The obstacle detecting device according to claim 1, wherein
the estimating section is configured to correct the position of the obstacle by use of a plurality of characteristics extracted from the in-mirror image.

3. The obstacle detecting device according to claim 1, wherein
the estimating section is configured to estimate the position of the obstacle by referring to a plurality of in-mirror images which are captured at respective points in time.

4. The obstacle detecting device according to claim 3, wherein
the estimating section is configured to also estimate at least one of (i) a moving direction of the obstacle and (ii) a moving speed of the obstacle.

5. The obstacle detecting device according to claim 1, wherein
the estimating section is configured to estimate the position of the obstacle by referring to a plurality of in-mirror images which are captured from respective positions.

6. The obstacle detecting device according to claim 1, wherein
the estimating section is configured to estimate the position of the obstacle by referring to information concerning the position of the obstacle, which information has been obtained from a second obstacle detecting device included in a second vehicle which is different from a vehicle including the obstacle detecting device.

7. A vehicle comprising:
the obstacle detecting device according to claim 1.

8. The vehicle according to claim 7, further comprising:
a control section,
the control section being configured to control the vehicle to stop in a case where the control section determines that the obstacle is located at a dangerous position.

9. The vehicle according to claim 7, further comprising:
a control section,
the control section being configured to control the vehicle to avoid the obstacle in a case where the control section determines that the obstacle is located at a dangerous position.

10. An obstacle detecting system comprising:
an obtaining section configured to obtain an in-mirror image reflected in a roadside mirror;
an extracting section configured to extract one or more characteristics from the in-mirror image; and
an estimating section configured to estimate a position of an obstacle by making a comparison between (i) the one or more characteristics extracted by the extracting section and (ii) map data.

11. The obstacle detecting system according to claim 10, further comprising:
a server configured to be able to communicate with a plurality of vehicles,
the server being configured to (i) record information concerning the position of the obstacle, which information has been obtained from a plurality of vehicles and (ii) transmit, to the plurality of vehicles, the information concerning the position of the obstacle.

12. The obstacle detecting device according to claim 2, wherein
the estimating section is configured to estimate the position of the obstacle by referring to a plurality of in-mirror images which are captured at respective points in time.

13. The obstacle detecting device according to claim 12, wherein
the estimating section is configured to also estimate at least one of (i) a moving direction of the obstacle and (ii) a moving speed of the obstacle.

14. The obstacle detecting device according to claim 2, wherein
the estimating section is configured to estimate the position of the obstacle by referring to a plurality of in-mirror images which are captured from respective positions.

15. The obstacle detecting device according to claim 2, wherein
the estimating section is configured to estimate the position of the obstacle by referring to information concerning the position of the obstacle, which information has been obtained from a second obstacle detecting device included in a second vehicle which is different from a vehicle including the obstacle detecting device.

16. A vehicle comprising:
the obstacle detecting device according to claim 2.

17. The vehicle according to claim 16, further comprising:
a control section,
the control section being configured to control the vehicle to stop in a case where the control section determines that the obstacle is located at a dangerous position.

18. The vehicle according to claim 16, further comprising:
a control section,
the control section being configured to control the vehicle to avoid the obstacle in a case where the control section determines that the obstacle is located at a dangerous position.

19. The obstacle detecting device according to claim 3, wherein
the estimating section is configured to estimate the position of the obstacle by referring to a plurality of in-mirror images which are captured from respective positions.

20. The obstacle detecting device according to claim 3, wherein
the estimating section is configured to estimate the position of the obstacle by referring to information concerning the position of the obstacle, which information has been obtained from a second obstacle detecting device included in a second vehicle which is different from a vehicle including the obstacle detecting device.
